(19) United States
(12) Patent Application Publication
(10) Pub. No.: US 2016/0264466 A1
(43) Pub. Date: Sep. 15, 2016

(54) BINDER COMPOSITIONS AND METHOD OF SYNTHESIS

(71) Applicant: Arizona Board of Regents on behalf of Arizona State University, Scottsdale, AZ (US)

(72) Inventors: Narayanan Neithalath, Chandler, AZ (US); David Stone, Tucson, AZ (US); Sumanta Das, Tempe, AZ (US)

(21) Appl. No.: 15/068,345

(22) Filed: Mar. 11, 2016

Related U.S. Application Data
(60) Provisional application No. 62/131,799, filed on Mar. 11, 2015.

(51) Int. Cl. C04B 28/00; C04B 28/02; C04B 28/10

(52) U.S. Cl. CPC C04B 28/00; C04B 28/10; C04B 28/021

(57) ABSTRACT

Some embodiments of the invention include cementitious iron carbonate binder precursor compositions that includes powdered iron or steel, a first powdered additive including silica, a second powdered additive including calcium carbonate, at least one powdered clay, and a fibrous and/or woven additive. In some embodiments of the invention, the precursor composition includes an alumina additive. In some further embodiments, the powdered clay includes kaolinite clay and/or metakaolin clay. In some further embodiments, the precursor composition includes an organic reducing agent such as oxalic acid. Some embodiments include up to about 60% by weight of powdered iron or steel, up to about 20% by weight of the first powdered additive, up to about 8% by weight of the second powdered additive, up to about 10% by weight of at least one powdered clay, and up to about 2% by weight of an organic acid.

### RELATED APPLICATIONS

This application claims priority from U.S. Provisional Application No. 62/131,799, filed on Mar. 11, 2015, the entire contents of which are incorporated herein by reference.

### STATEMENT REGARDING FEDERAL SPONSORED RESEARCH OR DEVELOPMENT

Some research conducted for conception and development of at least one embodiment of the invention described herein was made using Federal funds awarded by the National Science Foundation under Grant No. 1353170. The U.S. Federal Government has certain rights in the invention.

### BACKGROUND

Ordinary Portland Cement (OPC)-based materials (in particular, conventional cement concretes) are among the most common and cheapest ceramic matrices that are widely used for buildings and infrastructural applications. It is well recognized that OPC production is a significant emitter of CO₂, a major greenhouse gas, which is responsible for the global warming. The global concrete industry has embraced the idea of sustainability in construction through the use of waste/recycled materials as supplementary cementitious materials. For example, the use of materials such as fly ash, blast furnace slag, and limestone powder in concrete have reduced the scale of OPC production. Several non-conventional means of developing novel and sustainable matrix materials for infrastructural composites are also on-going.

Some binder systems can provide multiple environmental benefits through trapping of CO₂ emitted from industrial operations. For example, the utilization of a waste material (iron powder) that is otherwise land-filled, can also be used to reduce OPC production/use. The anoxic carbonation of (waste) metallic iron powder at ambient temperature and pressure has been shown to yield beneficial mechanical properties when use as a structural binder (see for example Das S, Souliman B, Stone D, Neithalath N. Synthesis and Properties of a Novel Structural Binder Utilizing the Chemistry of Iron Carbonation. ACS Appl. Mater. Interfaces 2014; 6(11):8295-304, and co-pending U.S. Patent Application No. 62/051,122 filed Sep. 16, 2014).

One of the major drawbacks of ceramic matrices in general and cementitious matrices in particular relate to their low toughness. In addition, these low-toughness ceramics lose a significant portion of their strength because of service-related damage such as crack growth under static load or cyclic fatigue. Thus, enhancing the toughness of these materials contributes to minimization and control of strength loss. In the synthesis of the iron-based binder, metallic iron powder is carbonated only to a small fraction (necessitated by limitations in reaction kinetics), which results in the presence of large amounts of residual metallic powder in the microstructure. The presence of this phase, a significant fraction of which is elongated, will likely render notable increase in the toughness of this binder because of the energy dissipation by plastic deformation imparted by the metallic particulate phase. In addition, the matrix contains other processing additives including harder fly ash particles, softer limestone particles, and ductile clayey phases which influence the overall fracture performance of the novel binder significantly.

Further opportunities exist to address the toughness performance of this novel binder system using additive reinforcement for applications such as building envelope components (e.g., exterior wall panels), precast elements, architectural claddings, as well as in electrically conductive ceramic composite applications.

### SUMMARY OF THE INVENTION

Some embodiments of the invention include a cementitious iron carbonate binder precursor composition comprising powdered iron or steel, a first powdered additive comprising silica, a second powdered additive comprising calcium carbonate, at least one powdered clay, and a fibrous and/or woven additive.

In some embodiments of the invention, the precursor composition comprises an alumina additive. In some further embodiments, the at least one powdered clay includes kaolinite clay and/or metakaolin clay. In some further embodiments, the precursor composition comprises at least one organic reducing agent. Some embodiments include an organic reducing agent that comprises oxalic acid.

In some embodiments of the invention, the fibrous or woven additive includes at least one of carbon fiber, cellulosic fiber, and metal fiber. In some further embodiments, the at least one fibrous of woven additive comprises glass fiber. In some embodiments, the glass fiber comprises alkali-resistant (“AR-glass”). In other embodiments, at least a portion of the glass fiber is in the form of glass mat, cloth, fabric, mesh, woven roving, an interwoven material, or combinations thereof.

In some embodiments of the invention, the first powdered additive comprises or is derived from limestone. In some further embodiments, the second powdered additive comprises or is derived from fly ash. In some embodiments of the invention, the powdered iron or steel originates or is derived from a by-product of one or more industrial processes. In some further embodiments, the limestone has a median particle size of about 0.7 μm conforming to ASTM C 568. In some other embodiments, the limestone has a particle size between 0.7 μm and 20 μm.

In some embodiments of the invention, the fibrous or woven additive comprises polymer fiber. In some embodiments, the polymer fiber comprises polypropylene, polyaramid, polycarbonate, polyvinyl alcohol, and/or nylon.

Some embodiments of the invention include a cementitious iron carbonate binder precursor composition comprising up to about 60% by weight of powdered iron or steel, up to about 20% by weight of a first powdered additive comprising silica, up to about 8% by weight of a second powdered additive comprising calcium carbonate, up to about 10% by weight of at least one powdered clay, and a fibrous and/or a woven additive.

In some embodiments, the first powered additive consists of fly ash, the second powdered additive consists of limestone, the at least one powdered clay consists of 10% metakaolin. Some embodiments also include at least one organic acid present as up to about 2% by weight of the precursor composition. In some further embodiments, the at least one fibrous or woven additive comprises a glass fiber.

### DESCRIPTION OF THE DRAWINGS

FIG. 1 illustrates particle size distributions of metallic iron powder, OPC, Fly ash, metakaolin, and limestone powder in accordance with some embodiments of the invention.

FIGS. 2A-2C illustrate micrographs showing the microstructure of iron-based binders in accordance with some embodiments of the invention.

FIG. 3 illustrates the flexural strengths of plain and fiber-reinforced iron carbonate binders after 6 days of carbonation and the corresponding OPC pastes after 28-days of hydration for comparison in accordance with some embodiments of the invention.

FIGS. 4A-4C show representative load-CMOD responses for iron carbonate binder compared with OPC systems in accordance with some embodiments of the invention.

FIG. 5A shows a plot of peak load for OPC and iron carbonate binders as a function of fiber volume fraction in accordance with some embodiments of the invention.

FIG. 5B shows a residual load of OPC and iron carbonate binders as a function of fiber volume fraction in accordance with some embodiments of the invention.

FIG. 6A shows a plot of fracture toughness for iron carbonate and OPC-based binders in accordance with some embodiments of the invention.

FIG. 6B shows a plot of critical crack tip opening displacements of iron carbonate and OPC-based binders in accordance with some embodiments of the invention.

FIG. 7A shows a plot of fracture toughness-critical crack tip opening displacement relationship with change in fiber dosage for iron carbonate binder and OPC in accordance with some embodiments of the invention.

FIG. 7B illustrates a plot of variation in critical crack length with change in fiber dosage for iron carbonate binder and OPC in accordance with some embodiments of the invention.

FIG. 8 illustrates resistance curves for the unreinforced and fiber reinforced iron-based and OPC binder systems in accordance with some embodiments of the invention.

FIG. 9A illustrates elastic and inelastic components of crack growth resistance with varying crack extension for iron carbonate binder for different fiber dosage in accordance with some embodiments of the invention.

FIG. 9B illustrates elastic and inelastic components of crack growth resistance with varying crack extension for OPC paste for different fiber dosage in accordance with some embodiments of the invention.

FIG. 10A shows a load-CMOD response for iron carbonate binder with 1% fiber volume fraction in accordance with some embodiments of the invention.

FIG. 10B shows a horizontal (u) displacement field represented as a 3D surface plot for iron carbonate binder with 1% fiber in accordance with some embodiments of the invention.

FIGS. 11A-11F show horizontal displacement fields and the 3D surface plots for unreinforced and reinforced (1% fiber volume fraction) iron-based binders in accordance with some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some embodiments of the invention include various compositions and synthesis methods of structural binders utilizing the chemistry of iron carbonation. In some embodiments, a structural binder can be formed by reaction of iron with carbon dioxide. Some embodiments include at least one fibrous and/or woven additive. For example, some embodiments include the addition of glass fiber to the iron-based binder systems. In some embodiments, glass fiber can be added to increase the toughness of the iron-based binder systems significantly over similarly reinforced OPC systems. In some embodiments, the glass fiber can be alkali-resistant glass (“AR-glass”) that is typically used in concrete applications. In some further embodiments, any conventional glass fiber compositions can be used. Further, some embodiments can include mixtures of various types of glass fibers. Further, some embodiments can include glass fibers, whiskers, and/or wires in the form of glass mat, cloth, fabric, mesh, woven roving, and/or any sheet of interwoven glass or other fibers with various size openings.

In some embodiments, the fibers can be any length from about 3 mm to about 24 mm. Some other embodiments can utilize fibers that are less than about 3 mm and/or greater than about 24 mm. In some embodiments, the volume fraction of glass fibers can be from 0.02% to 2% depending on the application. Further, in some embodiments, the specific gravity can be about 2.6, and in some embodiments, the moisture content can be less than about 0.5%. In some embodiments of the invention, the tensile strength can be about 1000 to about 1700 MPa. Some embodiments of the invention include glass fiber with a modulus of elasticity of about 72 GPa. In some embodiments, the glass fiber can comprise glass fibers manufactured by Corning Incorporated.

In some further embodiments, other types of fibers can be used including inorganic oxide fibers, metal fibers, polymer fibers (e.g., polypropylene), carbon fiber, or mixtures thereof. For example, other fibers that have been traditionally used in conventional concrete can be used including steel, carbon, aramid, polypropylene, polycarbonate, polyvinyl alcohol (“PVA”), nylon, asbestos, and natural plant-based fibers (e.g., plant derived materials comprising cellulose). In some embodiments, the reinforcing fibers including nylon, polypropylene, AR glass, steel, macro, high-dosage synthetic fibers, PVA, and steel/synthetic blends available from Nycon at http://nycon.com/ can be used. Further, in some embodiments, woven steel wire cloth of the type commonly used to make “ferrocement” structures for water tanks, boat hulls, and thin shell structures can be used.

In some embodiments, the carbon dioxide can be waste carbon dioxide obtained from one or more industrial processes. Some embodiments include methods to form a sustainable binder system for concretes through carbonation of iron dust. For example, in some embodiments, iron can react with aqueous CO₂ under controlled conditions to form complex iron carbonates which have binding capabilities. Further, some embodiments can include additives comprising silica and alumina. In some embodiments, silica and/or alumina additives can facilitate iron dissolution, which in some embodiments can provide beneficial rheological characteristics and properties. In some embodiments, the binder system can rely on the effects of corrosion of iron particles to form a binding matrix. In this instance, binder formation can result in the consumption and trapping of CO₂ from an industrial operation and subsequent carbonate formation by conversion of at least a portion of the iron particles. Further, the binder formation can provide a means to reduce the overall ordinary Portland cement production (which is itself a significant emitter of CO₂) through the use of carbonated metallic iron powder as the binder material for concrete.

In some embodiments, dissolution agents (such as organic acids) can be added to enhance the corrosion rate of iron. Further, in some embodiments, the rheological behavior (flowability and castability) and early strength development can be improved using one or more additives. For example, additives common to Portland cement concretes such as class F fly ash, powdered limestone, and metakaolin can be used as minor ingredients along with metallic iron powder to form pastes with adequate binding capabilities. The fly ash can be added as a source of silica to potentially facilitate iron silicate complexation. Further, in some embodiments, limestone powder can be added to provide additional nucleation sites. Some embodiments include one or more “powdered” clays having a layered structure which retains water and which can be used to improve the rheological properties. For example, in some embodiments, a clay source such as kaolinite and/or metakaolin can be used to provide consistency cohesiveness as the iron-based mixtures are prepared. This added clay source can also minimize the required water content.

Some embodiments provide compositions comprising fly ash, limestone, and a clay source such as metakaolin and/or kaolinite in various proportions. In some embodiments, the limestone powder can comprise a median particle size of about 0.7 μm conforming to ASTM C 568. In some embodiments, limestone can be added with a particle size that can range from a median size of about 0.7 μm to about 20 μm. In some embodiments, the fineness determines its nucleation ability. For example, in some embodiments, added limestone powder can provide nucleation sites for one or more cure reactions within the binder composition. In some embodiments, added water can be reduced in chemical reactions within any of the disclosed binder compositions (however it does not form part of the binder). In some embodiments, to minimize water demand, while maintaining binder consistency and cohesiveness, added metakaolin can be added to the binder composition. In some embodiments, the composition can comprise metakaolin conforming to ASTM C 618.

Some embodiments of the invention include compositions comprising metallic iron powder. In some further embodiments, an organic reducing agent/chelating agent of metal cations can be included in the binder composition. In some embodiments, the organic reducing agent comprises an acid. In some embodiments, the organic reducing agent comprises oxalic acid. In some embodiments, an organic reducing agent can be added in a powder form to about 2% of total weight of the constituents. In some other embodiments, the organic reducing agent can be added based on the solubility of the organic acid in water, and the compressive strength as compared to mixtures without dissociating agent.

In some embodiments, the proportions of iron powder and other additives (including for example organic acids as dissolution agents) can influence the curing regime (based at least in part on the exposure of the mixture to CO₂ and/or air). In some embodiments, the iron powder comprises about 88% iron and about 10% oxygen, along with trace quantities of copper, manganese, and calcium. In some embodiments, metallic iron powder sizes can range from about 5 μm to about 50 μm. For example, some embodiments comprise iron powder with a median particle size of about 19.03 μm. Further, in some embodiments, the selection of size ranges can facilitate reactivity. In some embodiments, the iron particles are elongated and angular in shape. In some embodiments, while influencing the rheological properties of the fresh mixture, the angular shape also provides benefits related to increased reactivity owing to the higher surface-to-volume ratio of the particles. In some embodiments, the iron powder can be obtained as a by-product of another industry process. For example, in some embodiments, the iron powder can be obtained from a shot-blasting facility.

Commercially available Type I/II OPC conforming to ASTM C 150 was used to prepare conventional cement pastes that were used as the baseline system to compare the properties of the novel iron-based binder systems. The chemical compositions of OPC, fly ash and metakaolin can be found in Vance K, Aguayo M, Oey T, Sant G, Neithalath N. Hydration and strength development in ternary Portland cement blends containing limestone and fly ash or metakaolin. Cem. Concr. Compos., 2013; 39:93-103, and Das S, Aguayo M, Dey V, Kachala R, Mobasher B, Sant G, et al. The fracture response of blended formulations containing limestone powder: Evaluations using two-parameter fracture model and digital image correlation. Cem. Concr, Compos., 2014; 53:316-26, the entire contents of which are incorporated by reference in their entirety. There is no restriction on the type and/or source of OPC, fly ash, or metakaolin, and any available conventional material can be used.

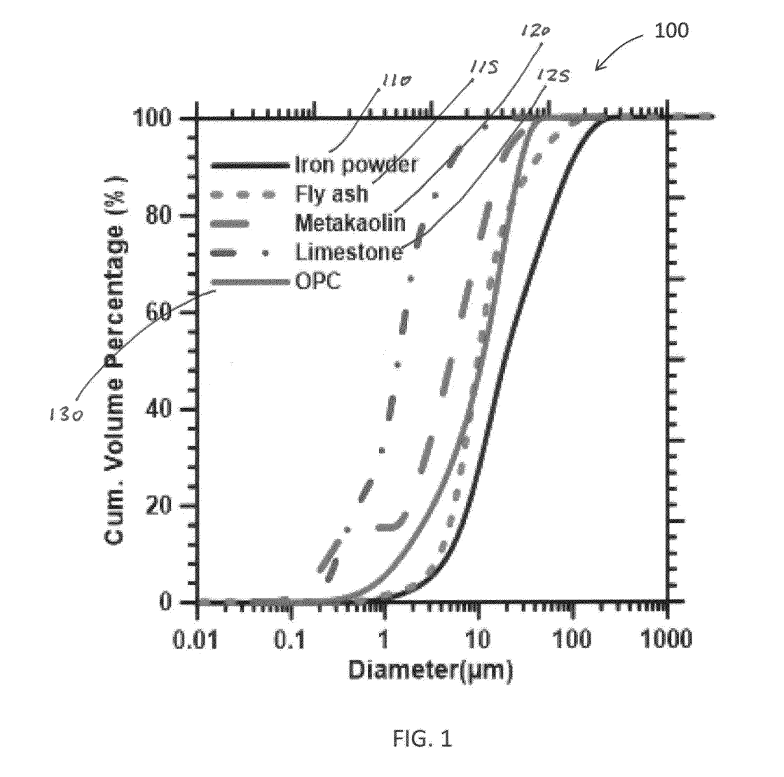

The particle size distributions (determined using dynamic light scattering) are shown in the plot 100 of FIG. 1 for iron powder (data line 110), fly ash (data line 115), metakaolin (data line 120), limestone (data line 125) and OPC (data line 130). The iron powder is coarser than all other ingredients used here. In some embodiments, the powder fraction of the iron-based binder mixture consists of 60% iron powder, 20% fly ash, 8% limestone, 10% metakaolin, and 2% organic acid by weight. This combination demonstrated the highest compressive strength and lowest porosity among a series of trial mixtures prepared as part of material design studies. These materials studies can be found in detail in Das S, Souliman B, Stone D, Neithalath N. Synthesis and Properties of a Novel Structural Binder Utilizing the Chemistry of Iron Carbonation. ACS Appl. Mater. Interfaces, 2014; 6(11):8295-304, the entire contents of which are incorporated by reference in their entirety.

In some embodiments, binder preparation includes a mixing procedure that involves initial dry mixing of all the starting materials, followed by the addition of water to obtain a substantially uniform cohesive mixture. Some embodiments of the invention can include a weight-based water-to-solids ratio (w/s) of 0.24 to attain a cohesive mix. In other embodiments, at least one of the powders forming the binder can be pre-mixed with water, and subsequently mixed with the remaining powders, or other pre-mixed water-powder mixtures.

Some embodiments include glass fiber reinforcement of the iron-based binder systems. In some embodiments, glass fiber can be added to improve the mechanical properties of the iron-based binder systems. For example, in some embodiments, fiber-reinforced binders can be prepared by adding about 0.5% and about 1.0% glass fibers by volume to the blends while mixing. In some embodiments, the glass fibers can be about 25 μm diameter and about 10 mm long). In some embodiments, the fiber reinforced iron-based and the OPC binders can be cured in the same way as their non-reinforced counterparts.

Table 1 provides a comparison of iron-based binder compositions of the invention with OPC compositions including compositions with and without fiber additions prepared as described above.

TABLE 1
Iron-based binder and OPC compositions

| | | Iron Carbonate | | | OPC | | |
|---|---|---|---|---|---|---|---|
| | | Fiber vol. fraction (%) | | | | | |
| | | 0 | 0.5 | 1 | 0 | 0.5 | 1 |
| Weight | Iron powder | 60 | 59.53 | 59.07 | NA | NA | NA |
| (%) | Fly ash | 20 | 19.84 | 19.69 | NA | NA | NA |
| | limestone | 8 | 7.94 | 7.88 | NA | NA | NA |
| | metakaolin | 10 | 9.92 | 9.84 | NA | NA | NA |
| | Oxalic acid | 2 | 1.98 | 1.97 | NA | NA | NA |
| | OPC | NA | NA | NA | 100 | 99.01 | 98.03 |
| | Glass fiber | 0 | 0.78 | 1.55 | 0 | 0.99 | 1.97 |
| | Water-to-powder | 0.24 | 0.24 | 0.24 | 0.4 | 0.4 | 0.4 |
| | ratio | | | | | | |

Prismatic specimens measuring about 127 mm (length), about 25.4 mm deep, and about 25.4 mm (width) were prepared in polypropylene molds and immediately placed inside clear plastic bags filled with 100% CO₂ in room temperature inside a fume hood. The samples were de-molded after 1 day of carbonation in order to attain enough strength to strip the molds without specimen breakage. After de-molding, the beams were again placed in a 100% CO₂ environment for another 5 days. The bags were refilled with CO₂ every 12 hours or so to maintain saturation. After the respective durations of CO₂ exposure, the samples were placed in air at room temperature to allow the moisture to evaporate for 4 days. These CO₂ and moisture exposure durations were considered because the mechanical properties demonstrated insignificant changes beyond these curing times. For the specimen sizes evaluated here, it can be safely assumed that these durations result in kinetic carbonation limits, and further carbonation generally cannot be achieved without changes in process conditions (e.g., temperature or pressure). Companion OPC mixtures of the same size as mentioned above were prepared with a water-to-cement ratio (w/cm) of 0.40, which is common for moderate-strength concretes in many buildings and infrastructural applications. The OPC beams were de-molded after 1 day and were kept in a moist chamber (>98% RH and 23±2° C.) for a total of 28 days.

The flexural strengths of both iron-based and OPC binders were determined using standard center-point loading as per ASTM C293/293M-10, on beams having a span of 101.6 mm. The fracture properties, viz., the critical stress intensity factor (K_{IC}^{S}) and the critical crack tip opening displacement (hereinafter “CTOD_{C}”), were determined from three-point bend tests on notched beams using the two-parameter fracture model (herein after “TPFM”), described in Jenq Y, Shah S P. Two parameter fracture model for concrete. J Eng. Mech. 1985; 111(10):1227-41, and Shah S P. Fracture mechanics of concrete: applications of fracture mechanics to concrete, rock and other quasi-brittle materials. John Wiley & Sons; 1995. For each mixture, four replicate beams were tested. The notch depth was 3.8 mm (corresponding to a notch depth-to-beam depth ratio of 0.15). The beams were tested in a crack mouth opening displacement (hereinafter “CMOD”)-controlled mode (CMOD acting as the feedback signal) during the loading cycles and in a load-controlled mode during the unloading cycles.

Microstructural analysis was performed on small rectangular pieces (10×10 mm in size). The samples were from the interior portions of the beams. Prior to mounting, the sample was ultrasonically cleaned and rinsed with ethyl alcohol and dried with compressed air spray to remove debris from sectioning/handling. After drying, the sample was placed into a 32 mm two-part mounting cup, filled with a room-temperature setting epoxy, and subjected to 95 kPa of vacuum for 5 minutes to remove entrapped air. After hardening, the sample was polished using 600 grit and 800 grit Silicon Carbide (SiC) abrasive discs, and further ground using 3 μm and 1 μm diamond paste. Final polishing was accomplished with 0.04 μm colloidal silica suspension.

Digital Image Correlation (“DIC”) was used for the determination of fracture properties. DIC is a non-contact optical method to analyze digital images to extract the full displacement field on a specimen surface. The beam surface was painted with random black and white speckles to improve image correlation. A charge coupled device camera was used to record images every 5 seconds during a loading and unloading sequence, and image correlation performed to obtain the displacement fields on the specimen surface within a specific analysis region.

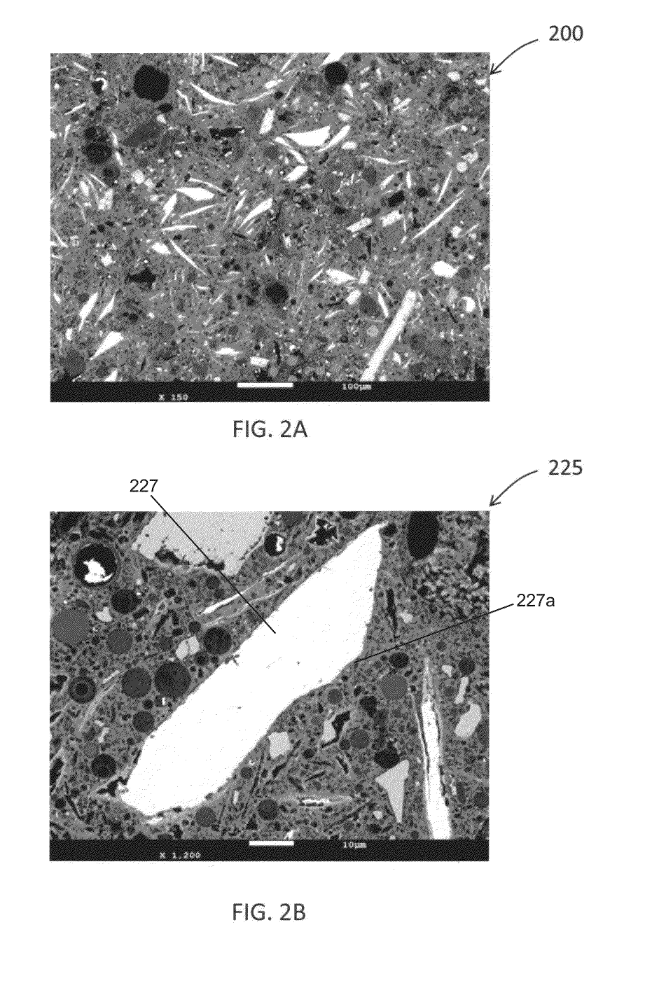

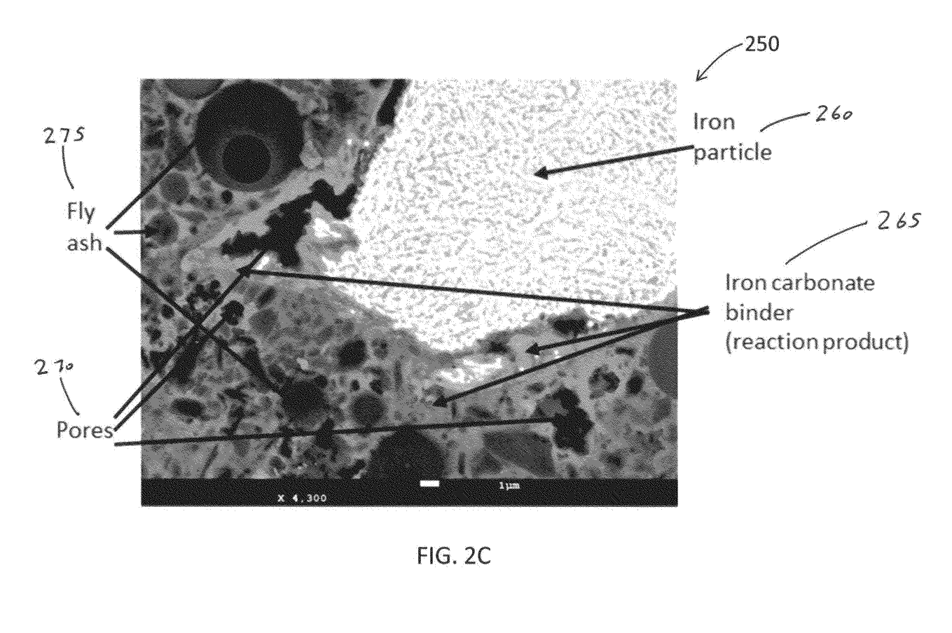

FIGS. 2A-2C illustrates micrographs showing the microstructure of iron-based binders. For example, FIG. 2A shows a lower magnification (150×) image 200 (scale bar corresponds to 100 μm), and FIG. 2B shows a higher magnification (1200×) image 225 showing an elongated iron particle and the surrounding regions (scale bar corresponds to 10 μm). Further, FIG. 2C shows a dissolution of Fe⁺² from iron particle into the surrounding matrix (4300×) (image 250 where a scale bar corresponds to 1 μm). The images shown are for specimens cured for 6 days in a CO₂ environment. FIG. 2A shows the general appearance of the material microstructure with bright (high density) iron particles along with the reaction products and pores. The unreacted iron particles are, in general, elongated. The dense reaction products (the grey phases in the microstructure) are formed from the carbonation of smaller iron particles and their complexation with the other minor ingredients in the mixture. This was confirmed from a thermal analysis study to be belonging to the carbonate-oxalate-cancrinite group, and described in Das S, Souliman B, Stone D, Neithalath N. Synthesis and Properties of a Novel Structural Binder Utilizing the Chemistry of Iron Carbonation. ACS. Appl. Mater. Interfaces 2014; 6(11):8295-304. A higher magnification image 225 is shown in FIG. 2B where an elongated iron particle 227 is at least partially surrounded by reaction product 227a, and the surrounding microstructure containing spherical fly ash particles is shown (annotated in the magnified image 250 of FIG. 2C as fly ash 275). The dark regions in this microstructure are the pores (annotated in FIG. 2C as pores 270), the volume fraction of which was found to be comparable to those of OPC-based systems as detailed in an extensive quantification work in the above described reference. FIG. 2C also shows the dissolution of iron into the matrix from the iron particle 260 and the formation of reaction products 265, where the iron carbonate binder (i.e., the reaction product 227a shown in FIG. 2B) can be seen at least partially surrounding the iron particle 260 as iron carbonate layer 265.

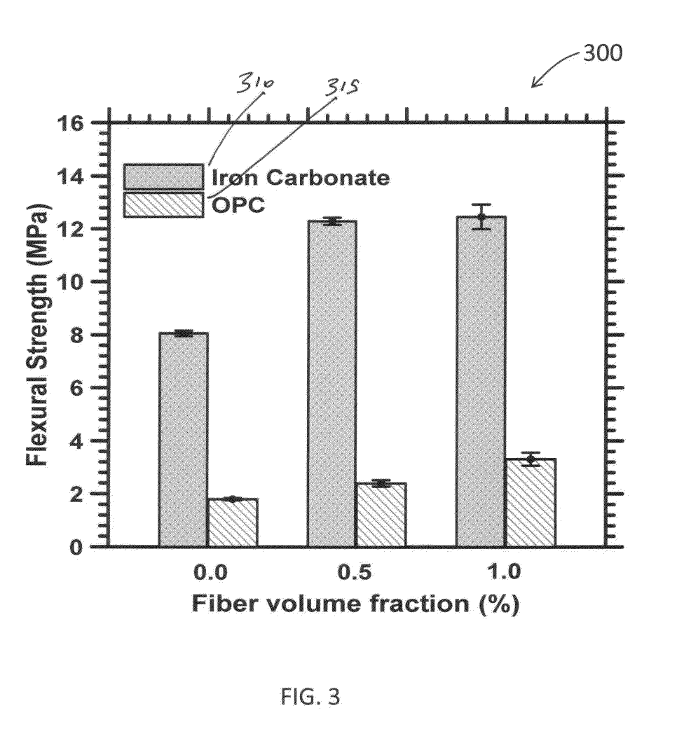

FIG. 3 illustrates a plot 300 showing the flexural strengths of plain (0% fiber) and fiber-reinforced (0.5% and 1%) iron carbonate binders after 6 days of carbonation and the corresponding OPC pastes after 28-days of hydration for comparison. The results presented here suggest that the iron carbonate binder (data bars 310) is about four-to-six times stronger than the traditional OPC paste in flexure (data bars 315). This can be attributed to a combination of the stronger carbonate matrix along with the presence of unreacted iron particles in the microstructure as shown in FIGS. 2A-2C. As illustrated, both binders are observed to exhibit increases in flexural strength with inclusion of fibers, with the iron-based system showing a much pronounced increase. While it has been proven that the addition of glass fiber in OPC systems results in an increase in toughness with only minor increase in flexural strength, the iron-based binder shows a different trend where the flexural strength is increased significantly with the incorporation of glass fibers into the matrix (e.g., see for example Sivakumar A, Santhanam M. Mechanical properties of high strength concrete reinforced with metallic and non-metallic fibers. Cem Concr Compos 2007; 29(8):603-8, and Altun F, Haktanir T, Ari K. Effects of steel fiber addition on mechanical properties of concrete and RC beams. Constr Build Mater 2007; 21(3):654-61, and Kwan W H, Ramli M, Cheah C B. Flexural strength and impact resistance study of fiber reinforced concrete in simulated aggressive environment. Constr Build Mater 2014; 63:62-71). An enhancement in flexural strength of about 50% is observed for the iron-based binder when 0.5% glass fibers by volume is incorporated, but further fiber addition does not appear to statistically enhance the material behavior, a behavior that is also observed for the Mode I fracture toughness of these binder systems.

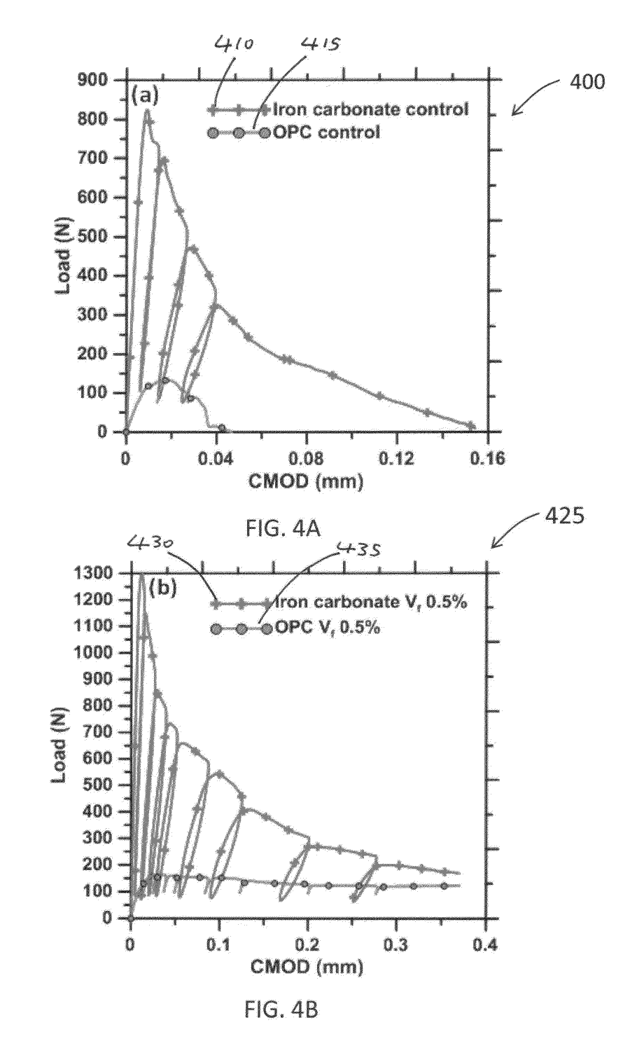

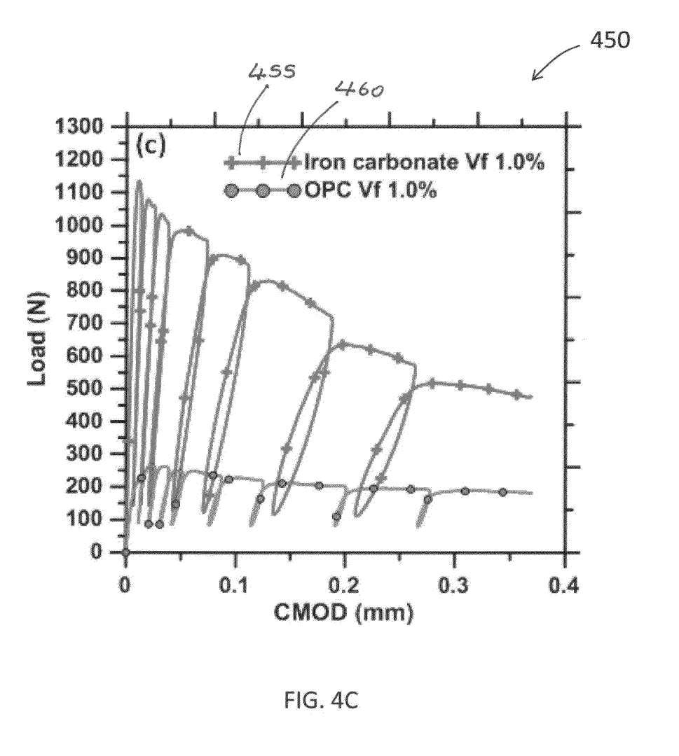

The fracture parameters of the iron-based and OPC binder systems were studied using the TPFM. TPFM idealizes the pre-peak non-linear behavior in a notched specimen through an effective elastic crack approach. The beam sizes and the notch depth are same for both the systems, thereby rendering the comparisons of the fracture parameters free of size effects. The effect of fiber volume fractions on the fracture parameters were also evaluated in conjunction with the response of the matrix phase. In some further embodiments, the cyclic load-CMOD response of notched beams was analyzed. The representative load-CMOD responses are shown in FIGS. 4A-4C for the iron-based binder and the companion OPC-based binder with and without fiber reinforcement, and depict representative load-CMOD responses for iron carbonate binder and comparison with OPC paste. For example, FIG. 4A shows plot 400 with data for control materials. FIG. 4B shows plot 425 with data for 0.5% fiber volume for iron-carbonate based binder (data line 430) and OPC-based binder (data line 435). Further, FIG. 4C shows plot 450 with data for 1.0% fiber volume fraction, with iron-carbonate based binder (data line 455) and OPC-based binder (data line 460). Plot 400 of FIG. 4A shows the load-CMOD response for the control OPC (data line 415) and iron-based binder without fiber reinforcement (data line 410), and clearly illustrates the fundamental differences in the flexural response of these matrices. The significantly higher peak load and improved post peak response of the iron-based binder as compared to control OPC binder can be attributed to the presence of unreacted metallic iron particles (as described earlier and shown in FIGS. 2A-2C) which are inherently strong and ductile. In some embodiments, the iron-based binder contains higher amounts of larger pores (average size>0.2 μm) even though the total pore volumes are comparable. Consequently, some embodiments of the invention demonstrate compressive strength that is slightly lower than that of the OPC binder. However, the presence of strong and ductile phases in the microstructure dominates the flexural response, as shown earlier.

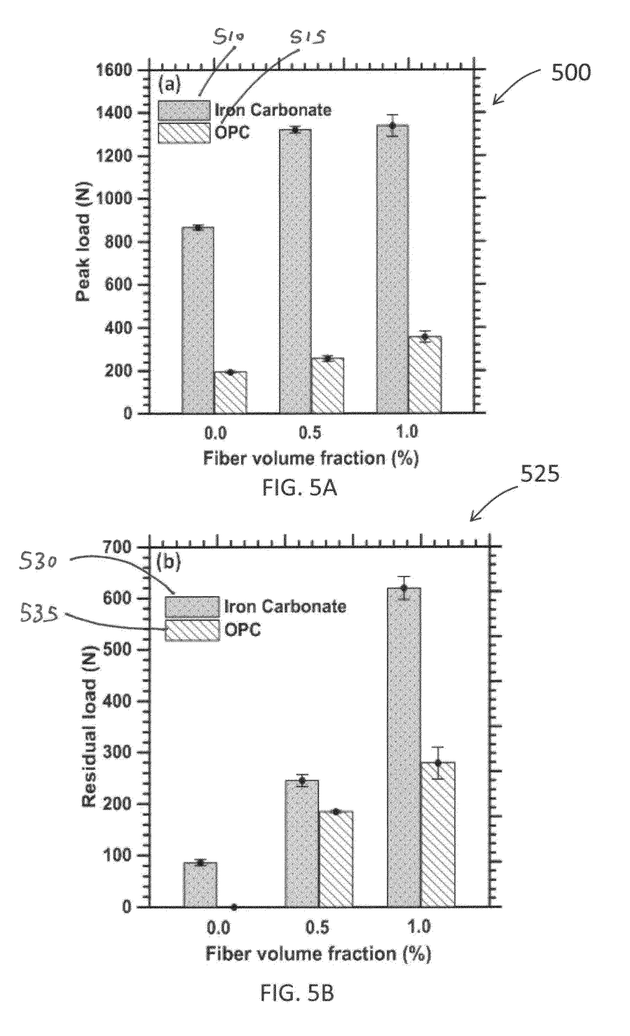

In some embodiments, the incorporation of fibers in an OPC matrix makes it ductile, as observed from the post-peak response and the larger CMODs for the fiber reinforced systems (as opposed to the unreinforced materials shown in FIGS. 4B and 4C). In some embodiments, both the peak load and the residual load are significantly higher for the iron carbonate binder, with and without fiber reinforcement (depicted in FIGS. 5A and 5B). For example, referring to FIG. 5A, iron-carbonate based binder (data line 510), and OPC-based binder (data line 515) is shown, and FIG. 5B, where iron-carbonate based binder (data line 530), and OPC-based binder (data line 535) is shown.

In some embodiments, the incorporation of glass fibers enhances the peak load of the iron-based binder much more than it does to the OPC binder, that can indicate the synergistic effect on flexural strength from the inclusion of the fiber in the iron carbonate matrix (including the unreacted iron particles). The residual load for the control binders was measured at a CMOD value of 0.12 mm, whereas a CMOD value of 0.25 mm was chosen for the binders with fiber reinforcement. In some embodiments, the residual loads provide an indication of the crack-tolerance and the post-peak response of these systems.

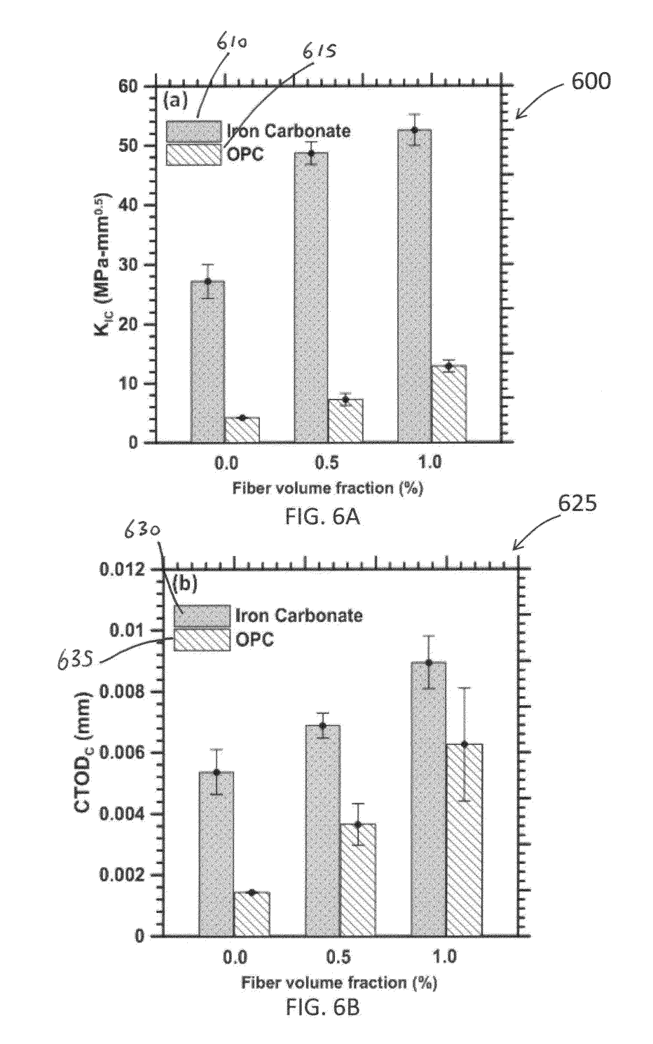

In some embodiments, an increase in fiber volume fraction is found to enhance the toughness of both the binder systems, and can be attributed to the crack-bridging effects of the fiber and the resultant increase in energy dissipation under load. For example, FIG. 6A shows a plot 600 of fracture toughness for iron carbonate-based binder (data bar 610), and OPC-based binders (data bar 615) in accordance with some embodiments of the invention, and FIG. 6B shows a plot 625 of critical crack tip opening displacements of iron carbonate-based binder (data bar 630) and OPC-based binders (data bar 635) in accordance with some embodiments of the invention. This data shows the two major fracture parameters of fracture toughness (“K_{IC}^{S}”) and CTOD_{C} derived using TPFM for both the binders, as a function of the fiber volume fraction. For example, FIG. 6A shows that the fracture toughness values of the iron-based binders are much higher than the control OPC binders (about 5-7 times higher) irrespective of the fiber volume fraction. In some embodiments, the K_{IC}^{S} values of the iron carbonate binder range from 30 MPa·mm^{0.5} to 50 MPa·mm^{0.5}, which is approximately half of those of glass ceramics, polycrystalline cubic zirconia, SiN, alumina, and high-performance structural ceramics such as SiC, and about five times larger than the companion OPC binder. The ceramic systems mentioned earlier can be ten to thirty times more expensive than the iron-based binder.

In the unreinforced OPC matrix, the mechanism of strain energy dissipation can include crack extension. In some embodiments, the significantly higher K_{IC}^{S} of the iron-based binder, even for the unreinforced case, as compared to the OPC binder can be attributed to the crack bridging and/or deflection effects of the ductile, unreacted metallic iron particles in the matrix. As illustrated in FIGS. 2A-2C, many of the unreacted metallic iron particles are elongated. In some embodiments, these particles can function as a reinforcing phase that imposes a closing pressure on the crack. In some embodiments, this can bridge the cracks and the elastic incompatibility and de-bonding between the metallic particle-carbonate matrix interfaces can contribute to crack deflection.

In some embodiments of the invention, beyond a certain volume fraction of fibers, further toughness enhancement is negligible for the iron-based binders because the distribution of the unreacted iron particles and the fibers in the matrix is expected to be sufficient for crack bridging/deflection. The CTOD_{C}, which indicates the limit beyond which unstable crack propagation begins is shown in FIG. 6B as a function of the fiber volume fraction for both the binders. As shown, in some embodiments, a uniform increase in CTOD_{C} with fiber volume fraction can be observed for both the binders. Further, in some embodiments, the unstable crack propagation threshold limit (CTOD_{C}) for the unreinforced iron-based control binder is found to be about three times higher as compared to that of the corresponding OPC paste. The difference in CTOD_{C} between the two binder types reduces as fibers are incorporated. Further, in some embodiments, the KIC and CTOD_{C} values of the two binders indicate that the iron-based binder yields significantly improved crack resistance and ductility than the conventional OPC systems due to the presence of unreacted metallic iron powder surrounded by a carbonate matrix.

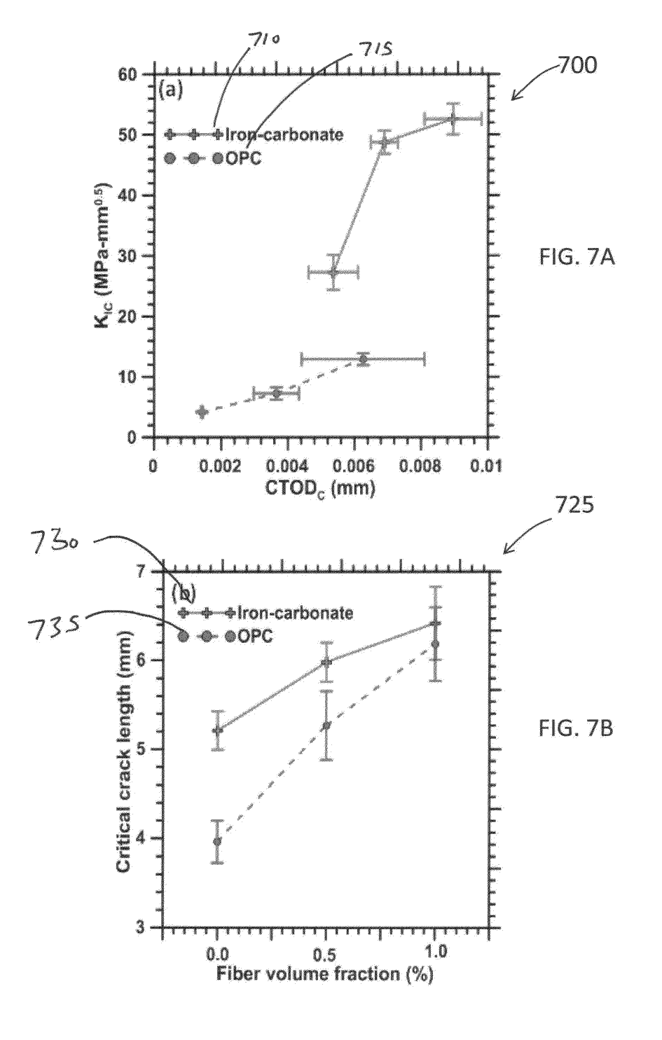

The K_{IC}^{S}-CTOD_{C} relationships of the two binders are compared in FIG. 7A, showing a plot 700 of fracture toughness-critical crack tip opening displacement relationship with change in fiber dosage for iron carbonate-based binder (data line 710) and OPC-based binder (data line 715) in accordance with some embodiments of the invention. In some embodiments, an increase in the fracture toughness is observed with an increase in the critical opening size of the crack. Further, while the increase in K_{IC}^{S} is proportional to an increase in CTOD_{C} for the OPC binders, in some embodiments, for the iron carbonate-based binder, the increase in K_{IC}^{S} is not prominent beyond a certain CTODc value (or fiber volume fraction since CTOD_{C}-fiber volume fraction relationships are linear for both the binder systems. This is illustrated in FIG. 7B, showing a plot 725 of variation in critical crack length with change in fiber dosage for iron carbonate-based binder (data line 730) and OPC-based binder (data line 735) in accordance with some embodiments of the invention. In some embodiments, the critical crack length increases with increase in fiber volume for both the binders. In unreinforced binders, the iron-based system has a higher critical crack length owing to the contribution from elongated, elastic iron particles. However, at a higher fiber volume fraction, the critical crack lengths for both the binders are comparable even though K_{IC}^{S} and CTOD_{C} are higher for the iron-based binder. This shows that in the iron-based systems, in some embodiments, beyond a certain fiber volume fraction, enhancement in fracture properties are negligible even though the performance is much better than the corresponding OPC systems.

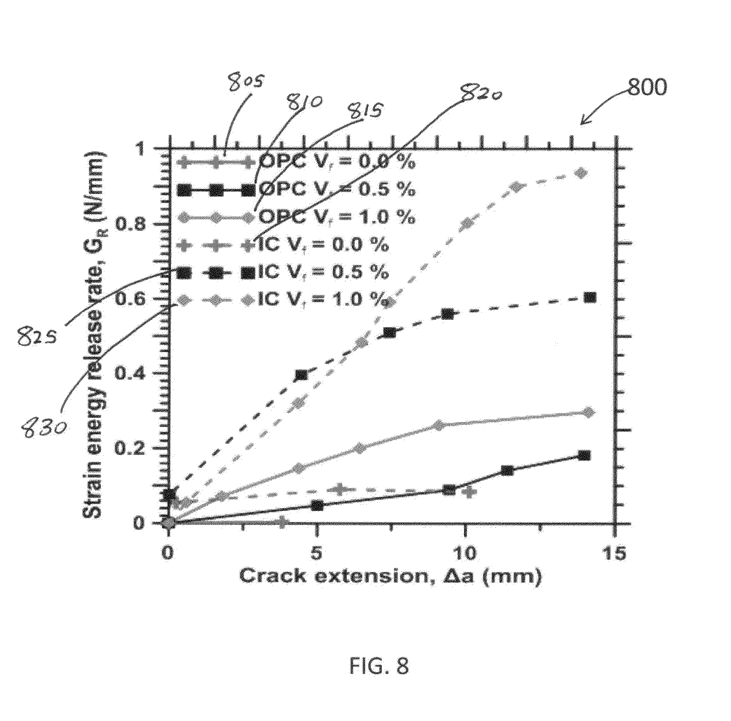

In some embodiments of the invention, the existence of unreacted, elongated iron particles and added fibers can influence and modify the fracture response. This can be examined using resistance curves (“R-curves”), by making use of the multiple loading-unloading cycles in the load-CMOD plots. For example, FIG. 8 illustrates resistance curves (data lines 805, 810, 815, 820, 825, 830) for the unreinforced and fiber reinforced iron-based and OPC binder systems in accordance with some embodiments of the invention. FIG. 8 shows the R-curves for both the binder systems at all levels of fiber reinforcements. For example, data lines 805, 810, 815 show OPC-based binder data at 0%, 0.5%, and 1% volume fraction of fiber reinforcement, and data lines 820, 825, 830 show iron-carbonate-based binder data at 0%, 0.5%, and 1% volume fraction of fiber reinforcement. “R” is defined as the strain energy rate required for crack propagation and it is an increasing and convex function for quasi-brittle materials. The contributions from both the elastic and inelastic strain energies are considered in the development of the R-curve. The elastic component can be calculated from the unloading compliances whereas the inelastic CMOD is used to calculate the inelastic strain energy release rate. Three parameters were obtained for each loading-unloading cycle including the compliance, the load at the initiation of the unloading, and inelastic CMOD, which is the residual displacement when the sample is unloaded. The R-curves comprise of a region where the resistance increases with crack length denoting the formation of a process zone and an energy plateau denoting steady-state crack extension. In some embodiments, the location of the transition point between the two regions depends on the matrix type and fiber volume. In some embodiments, the unreinforced OPC system shows almost negligible resistance whereas the corresponding iron-based system demonstrates some resistance to crack formation and growth, attributable to the reasons described elsewhere in this paper. Hence, in some embodiments, the use of fiber reinforcement improves the crack growth resistance of OPC systems, but the overall resistances are significantly lower than those of the iron-based binder systems.

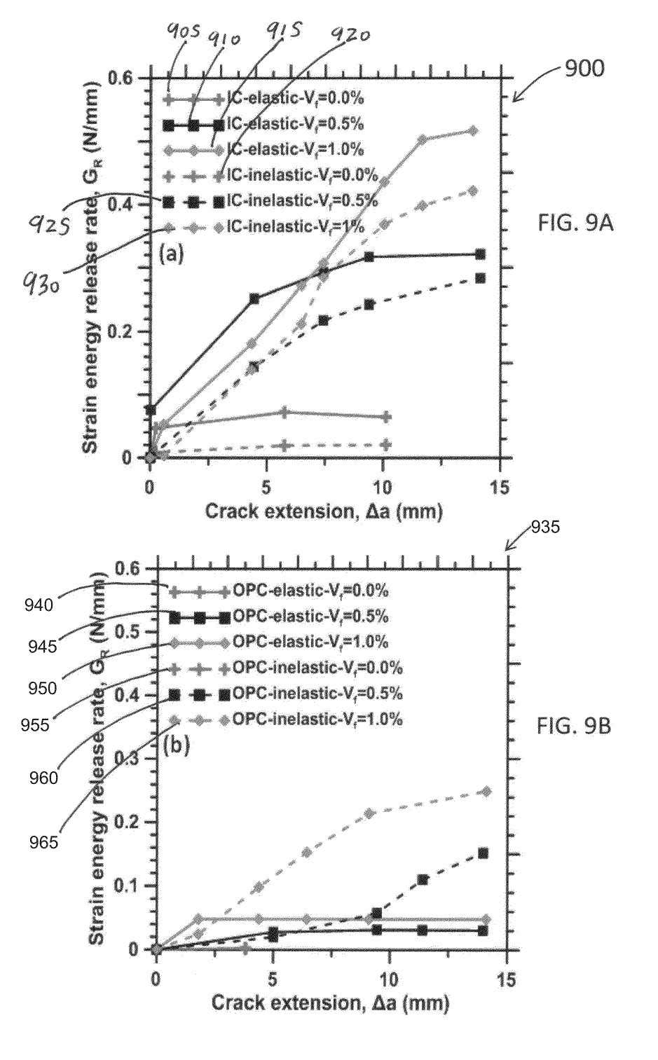

The elastic and inelastic components of the strain energy release rate can be separated to obtain further insights on the relative influence of matrix (and the discrete phases in it), and the relative influence of matrix fiber reinforcement on the fracture response of these widely different material systems. The elastic component of the strain energy release rate corresponds to the energy release rate due to incremental crack growth whereas the inelastic component corresponds to effects such as permanent deformation caused due to crack-opening. For example, plot 900 of FIG. 9A illustrates elastic and inelastic components of crack growth resistance with varying crack extension for iron carbonate binder for different fiber dosage in accordance with some embodiments of the invention. For example, data lines 905, 910, 915 comprise elastic component response for iron-carbonate-based binder data at 0%, 0.5%, and 1% volume fraction of fiber reinforcement, and data lines 920, 925, 930 show the inelastic response for iron-carbonate-based binder data at 0%, 0.5%, and 1% volume fraction of fiber reinforcement. Further, plot 935 of FIG. 9B illustrates elastic and inelastic components of crack growth resistance with varying crack extension for OPC paste for different fiber dosage in accordance with some embodiments of the invention. For example, data lines 940, 945, 950 comprise elastic component response for iron-carbonate-based binder data at 0%, 0.5%, and 1% volume fraction of fiber reinforcement, and data lines 955, 960, 965 show the inelastic response for iron-carbonate-based binder data at 0%, 0.5%, and 1% volume fraction of fiber reinforcement. As indicated, in some embodiments, the contribution of the elastic component to the overall strain energy release rate is found to be higher than the inelastic component for the iron-based binder systems (both unreinforced and reinforced). However, for the OPC systems, the contribution of inelastic component is higher. Further, in some embodiments, both the elastic and the inelastic components increase with increase in crack extension for the fiber-reinforced iron-based system, However, for the fiber-reinforced OPC systems, the elastic component remains relatively constant with crack extension, and the increase in total strain energy is mainly due to increase in the inelastic component.

In some embodiments, the higher contribution of the elastic component in the iron-based systems can be attributed to the presence of a stronger matrix along with the presence of elastic metallic iron particles that provide crack growth resistance through the mechanisms described earlier. On the contrary, the brittle OPC matrix cracks easily, and consequently the load is carried almost completely by the fibers. The fibers bridge the crack, and energy dissipation is obtained through crack opening, which is reflected in the form of increased inelastic strain energy with increasing crack extension. The R-curve response is consistent with the values of fracture parameters (K_{IC}^{S} and CTOD_{C}) of these binders. In some embodiments, the fracture toughness of the iron-based systems was found to be much higher than the OPC systems whereas the CTOD_{C} values demonstrated less of a difference. The same trends are reflected in the R-curves: about an order of magnitude higher crack growth resistance (elastic contribution) observed for the iron-based systems than the OPC systems and comparatively lesser improvement (about 60% higher) in the crack-opening resistance (inelastic contribution).

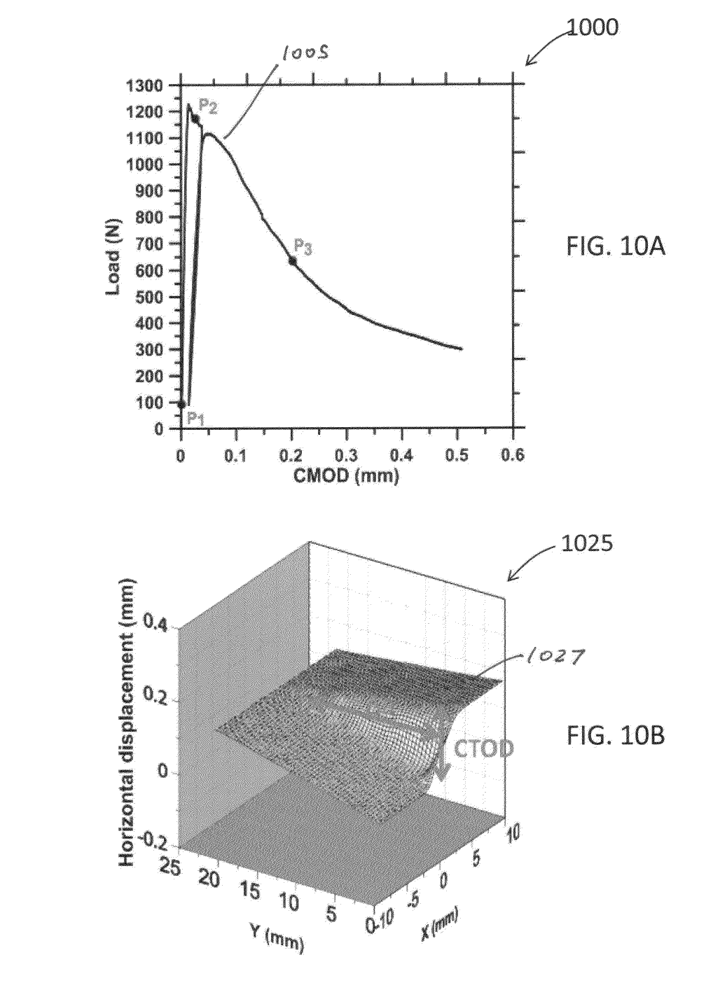

Digital image correlation (“DIC”) can be used to determine K_{IC} and CTOD_{c} of the binder systems. Two representative iron carbonate binders (0% and 1% fiber volume fraction) were examined for the extraction of fracture parameters through DIC. For example, FIG. 10A shows a load-CMOD response plot 1000 for iron carbonate binder with 1% fiber volume fraction in accordance with some embodiments of the invention, and FIG. 10B shows a horizontal (u) displacement field represented as a 3D surface plot 1025 for iron carbonate binder with 1% fiber in accordance with some embodiments of the invention. Referring to plot 1000 of FIG. 10A, the load-CMOD response for the fiber-reinforced iron-based binder can be seen as data line 1005, where the points P1, P2, P3 correspond to three different stages of crack extension (i.e., in the pre-peak, near-peak, and post-peak stages). The compliance value obtained by unloading at approximately 95% of the peak load in the post-peak region is used for the determination of K_{IC}^{S} and CTOD_{C} using TPFM, which is required in order to compare with the corresponding values obtained using the DIC technique. The horizontal u-displacement fields (along the crack opening direction) are obtained from image correlation. The plot 1025 of FIG. 10B shows crack opening behavior curve 1027, denoted by the horizontal displacement, and the crack extension, denoted by the jump in the displacement above the notch (extracted from the DIC data). As can be observed, in some embodiments, the CTOD and Δa values can be determined directly using the DIC method without instrumenting the crack for precise measurements. A threshold value of 0.005 mm is set to qualify the displacement-jump as contributing to crack extension. The crack extension corresponding to 95% of the peak load in the post-peak region is used to determine the DIC-based fracture toughness parameters using a set of simplified expressions as shown later.

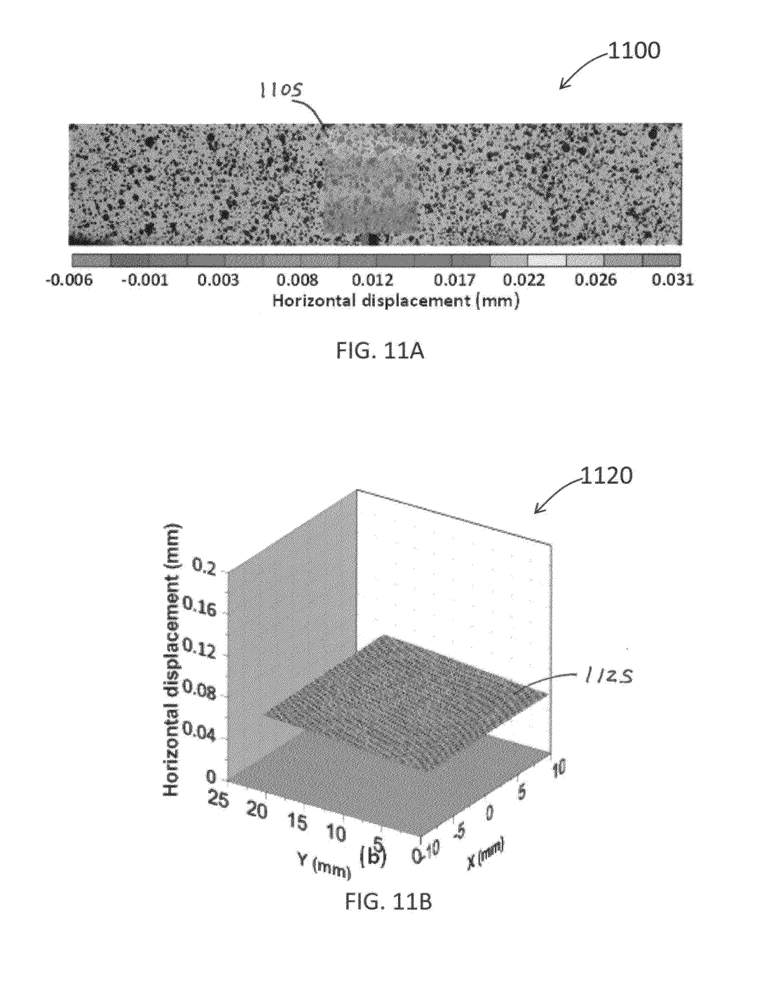

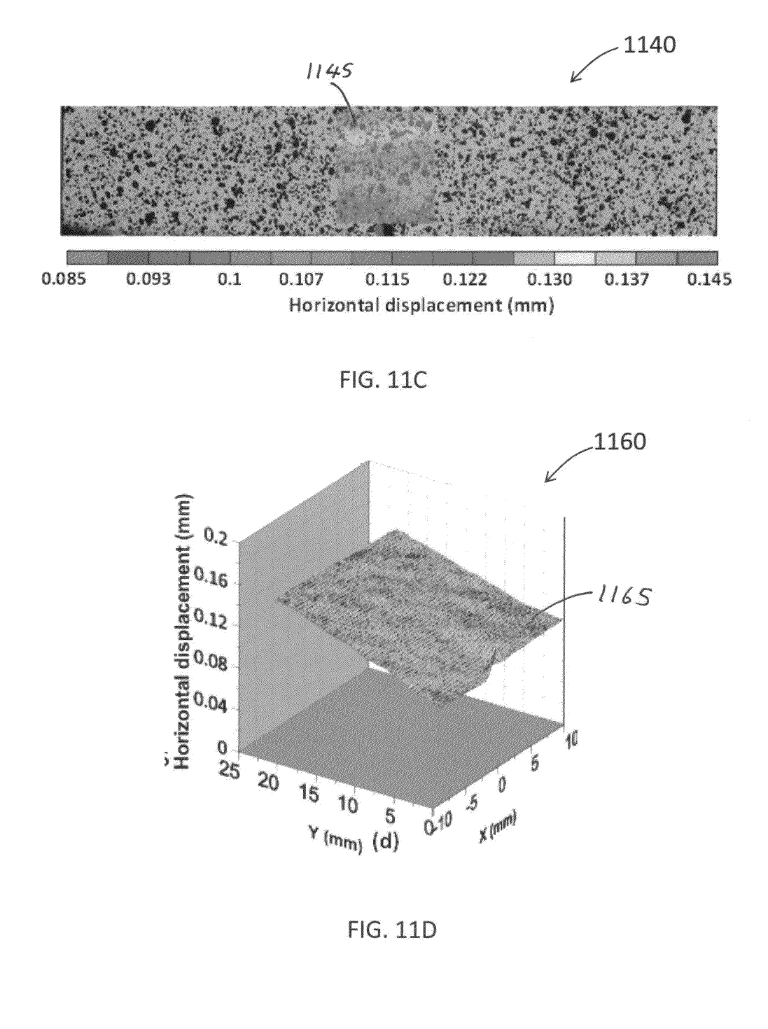

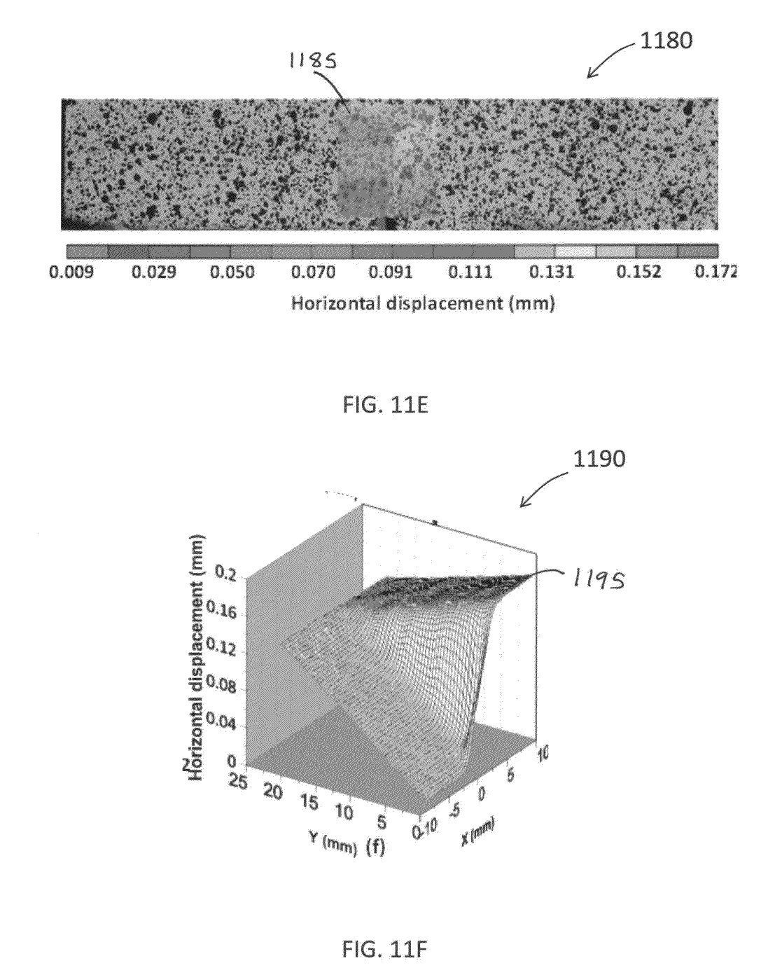

FIGS. 11A-11F show horizontal 2D displacement fields and the 3D surface plots for unreinforced and reinforced (1% fiber volume fraction) iron-based binders in accordance with some embodiments of the invention. The plots correspond to: (a) and (b) pre-crack stage: P1 (CMOD: 0.0009 mm, Load: 91.4 N, =0 mm, CTOD=0 mm); (c) and (d) stable crack growth stage: P2 (CMOD: 0.0263 mm, Load: 1172 N, =3.95 mm, CTOD=0.0096 mm); (e) and (f) unstable crack-propagation stage: P3 (CMOD: 0.2019 mm; Load: 633.8 N; =18.58 mm; CTOD=0.156 mm) in accordance with some embodiments of the invention. As shown, the 2D displacement fields for the iron-based binder are shown for three different CTOD values which were selected as shown in FIG. 10A (“P1”, “P2”, and “P3”), where FIGS. 11A, 11C, and 11E show the 2D crack opening displacements, corresponding to the points P1, P2 and P3 of FIG. 10A. Further, FIGS. 11B, 11D, and 11F show the corresponding horizontal displacements as 3D surface plots 1120, 1160, 1190 for 2D surface regions 1105, 1145, and 1185 respectively. Plot 1100 of FIG. 11A corresponds to the case where only a very small load is applied to the specimen (point “P1” in FIG. 10A), and the values of both CTOD and crack extension are zero, as shown by the uniform horizontal displacement fields above the notch as well as a flat surface plot (#D plot 1125 of FIG. 11B). FIG. 11C corresponds to 95% of the peak load in the post-peak zone (Point “P2” in FIG. 10A). A displacement jump is clearly visible above the notch in both the 2D displacement field (FIG. 11C) and the 3D surface plot (3D plot 1165 of FIG. 11D). Beyond this point, the crack extension is found to be unstable (a large increase in CTOD and crack extension). FIG. 11E shows the displacement field corresponding to Point “P3” in FIG. 10A, and the 3D surface plot (3D plot 1195 of FIG. 11F). The CTOD and Δa values are very high in the post-peak zone.

CTOD_{C} and KIC values are shown Table 2 (obtained using calculated TPFM and DIC methods). For the iron-based binders, the data indicates a there is a correlation between the KIC and CTODc values obtained from the contact and non-contact methods.

TABLE 2
Comparison of the KIC and CTODc values determined using

| | K_{IC} (MPa · mm^{0.5}) | | CTOD_{c} (mm) | |
|---|---|---|---|---|
| Specimen composition | TPFM | DIC | TPFM | DIC |
| Iron carbonate (Control) | 31.40 | 33.56 | 0.0062 | 0.0040 |
| Iron carbonate (V_{f} = 1.0%) | 52.53 | 54.14 | 0.0089 | 0.0096 |

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A cementitious iron carbonate binder precursor composition comprising:
powdered iron or steel;
a first powdered additive comprising silica;
a second powdered additive comprising calcium carbonate;
at least one powdered clay; and
at least one of a fibrous or a woven additive.

2. The composition of claim 1, further comprising an alumina additive.

3. The composition of claim 1, wherein the at least one powdered clay includes at least one of a kaolinite clay and a metakaolin clay.

4. The composition of claim 1, further including at least one organic reducing agent.

5. The composition of claim 4, wherein the at least one organic reducing agent comprises oxalic acid.

6. The composition of claim 1, wherein the at least one fibrous or woven additive includes at least one of carbon fiber, cellulosic fiber, and metal fiber.

7. The composition of claim 1, wherein the at least one fibrous of woven additive comprises glass fiber.

8. The composition of claim 7, wherein the glass fiber comprises alkali-resistant (“AR-glass”).

9. The composition of claim 7, wherein at least a portion of the glass fiber is in the form of glass mat, cloth, fabric, mesh, woven roving, an interwoven material, or combinations thereof.

10. The composition of claim 1, wherein the first powdered additive comprises or is derived from limestone.

11. The composition of claim 1, wherein the second powdered additive comprises or is derived from fly ash.

12. The composition of claim 1, wherein the powdered iron or steel originates or is derived from a by-product of one or more industrial processes.

13. The composition of claim 1, wherein the at least one fibrous or woven additive comprises polymer fiber.

14. The composition of claim 13, wherein the polymer fiber comprises at least one of polypropylene, polyaramid, polycarbonate, polyvinyl alcohol, and nylon.

15. The composition of claim 10, wherein the limestone has a median particle size of about 0.7 μm conforming to ASTM C 568.

16. The composition of claim 10, wherein the limestone has a particle size between 0.7 μm and 20 μm.

17. A cementitious iron carbonate binder precursor composition comprising:
up to about 60% by weight of powdered iron or steel;
up to about 20% by weight of a first powdered additive comprising silica;
up to about 8% by weight of a second powdered additive comprising calcium carbonate;
up to about 10% by weight of at least one powdered clay;
at least one of a fibrous and a woven additive.

18. The composition of claim 17, wherein the first powered additive consists of fly ash, the second powdered additive consists of limestone, and the at least one powdered clay consists of metakaolin or kaolinite clay.

19. The composition of claim 18, further comprising at least one organic acid present as up to about 2% by weight of the precursor composition.

20. The composition of claim 18, wherein the at least one fibrous or woven additive comprises a glass fiber.
